(19) United States
(12) Patent Application Publication
(10) Pub. No.: US 2012/0126621 A1
(43) Pub. Date: May 24, 2012

(54) LIGHTING SYSTEM

(76) Inventor: Michael Scott Brownlee, San Francisco, CA (US)

(21) Appl. No.: 13/294,174

(22) Filed: Nov. 10, 2011

Related U.S. Application Data
(60) Provisional application No. 61/411,923, filed on Nov. 10, 2010.
(60) Provisional application No. 61/411,924, filed on Nov. 10, 2010.

(51) Int. Cl. H02J 9/00

(52) U.S. Cl. 307/64

(57) ABSTRACT

A system includes an electrical load and a power storage system. The system includes a control assembly which controls the flow of a first power signal to the electrical load and power storage system. The control assembly controls the flow of a second power signal between the power storage system and electrical load. The system includes a housing which carries the power storage system and control assembly.

### CROSS-REFERENCE TO RELATED APPLICATIONS

This patent application claims the benefit of U.S. Provisional Application No. 61/411,923, filed on Nov. 10, 2010, the contents of which are incorporated by reference as though fully set forth herein.

This patent application claims the benefit of U.S. Provisional Application No. 61/411,924, filed on Nov. 10, 2010, the contents of which are incorporated by reference as though fully set forth herein.

### BACKGROUND OF THE INVENTION

1. Field of the Invention

This invention relates generally to electrical circuits and controlling the operation thereof.

2. Description of the Related Art

It is desirable to control the operation of an electrical load. The operation of the electrical load can be controlled in many different ways, such as by turning it on and off. the operation of the electrical load can also be controlled by controlling the power source which drives it. For example, some electrical loads are driven by a main power source, such as through an electrical outlet of a building. The electrical load cannot be driven, however, when the main power source is not available, such as during a power outage. Further, it is well-known that the cost of using the main power source varies throughout the day. Hence, it is desirable to use the main power source when the cost is lower, and to have an alternative power source when the cost of the main power source is higher.

### BRIEF SUMMARY OF THE INVENTION

The present invention is directed to a system which controls the operation of an electrical load, and provides power storage. The novel features of the invention are set forth with particularity in the appended claims. The invention will be best understood from the following description when read in conjunction with the accompanying drawings.

### BRIEF DESCRIPTION OF THE DRAWINGS

FIG. 1a is a block diagram of a system which controls the operation of an electrical load, and provides power storage.

FIG. 1b is a block diagram of one embodiment of an electrical load of the system of FIG. 1a.

FIG. 1c is a block diagram of one embodiment of a load system controller of the system of FIG. 1a.

FIG. 1d is a block diagram of one embodiment of power storage device of the system of FIG. 1a.

FIG. 1e is a circuit diagram of one embodiment of power storage controller of the system of FIG. 1a.

FIG. 2a is a perspective view of load device of the system of FIG. 1a embodied as a solid-state light emitting device.

FIG. 2b is a perspective view of a load device of the system of FIG. 1a embodied as a lamp.

FIG. 3 is a block diagram of a system which controls the operation of an electrical load, and provides power storage.

FIG. 4 is a block diagram of a system which controls the operation of an electrical load, and provides power storage.

FIG. 5 is a block diagram of a system which controls the operation of an electrical load, and provides power storage.

FIGS. 6a and 6b are block diagrams of circuits which are included in a light switch assembly of the system of FIG. 5.

### DETAILED DESCRIPTION OF THE INVENTION

The invention involves a system which controls the operation of an electrical load, and provides power storage. The systems are discussed in more detail below with reference to the drawings. It should be noted that like reference characters are used throughout the several views of the Drawings.

The system can be made in many different ways, such as by using integrated and/or discrete circuit components. The circuit components can be of many different types, such as microcontrollers, switches and relays, as well as resistors, capacitors and/or inductors. The circuit components are manufactured by many different companies, such as Microchip, Inc. of Chandler, Ariz. and National Semiconductor, Inc. of Santa Clara, Calif., among others. In some embodiments, the circuit components include a wireless module, which provides a control signal between controllers.

More information regarding certain aspects of the system can be found in the above-referenced U.S. Provisional Application Nos. 61/411,923 and 61/411,924. More information regarding certain aspects of the system can be found in U.S. patent application Ser. No. 12/553,893, filed on Sep. 3, 2009, the contents of which are incorporated by reference as though fully set forth herein. U.S. patent application Ser. No. 12/553,893 is related to U.S. Provisional Application No. 61/093,721, filed on Sep. 3, 2008, U.S. Provisional Application No. 61/238,139, filed on Aug. 29, 2009 and U.S. Provisional Application No. 61/239,013, filed on Sep. 1, 2009, and more information regarding certain aspects of the system can be found these provisional applications. Hence, U.S. Provisional Application Nos. 61/093,721, 61/238,139 and 61/239,013 are incorporated by reference as though fully set forth herein.

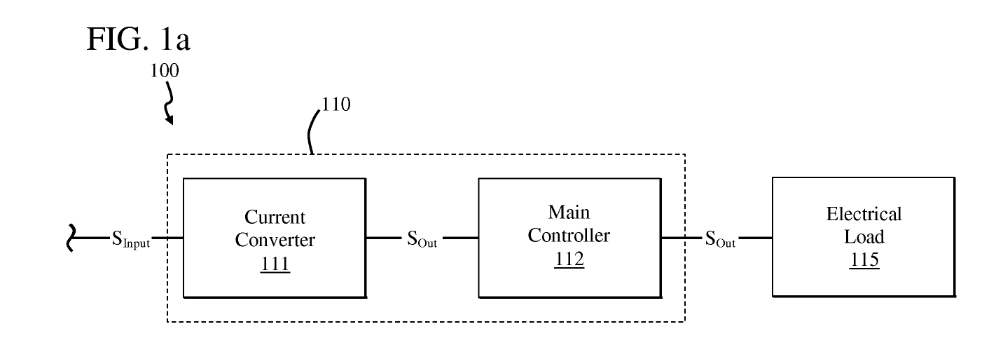

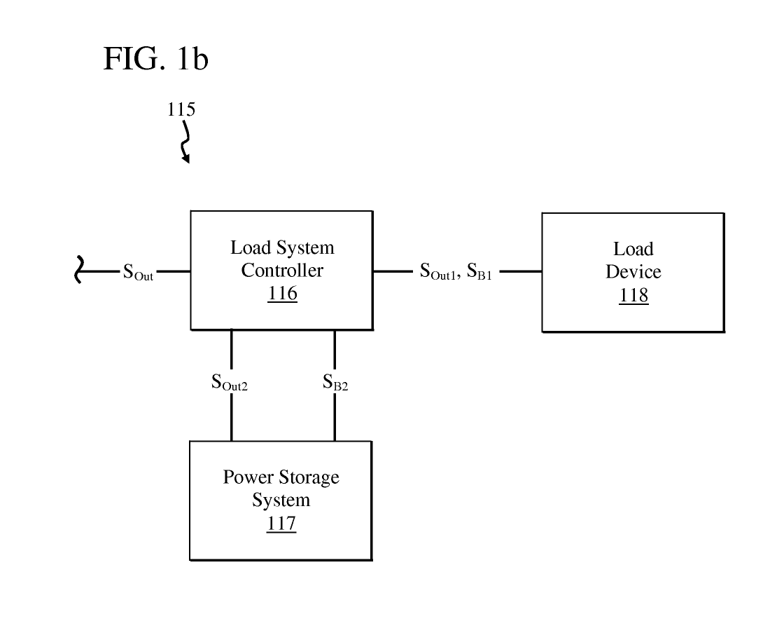

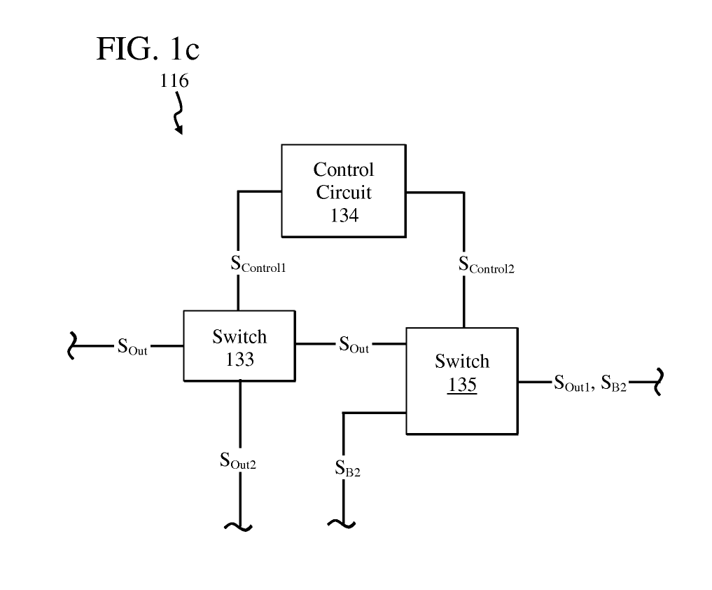

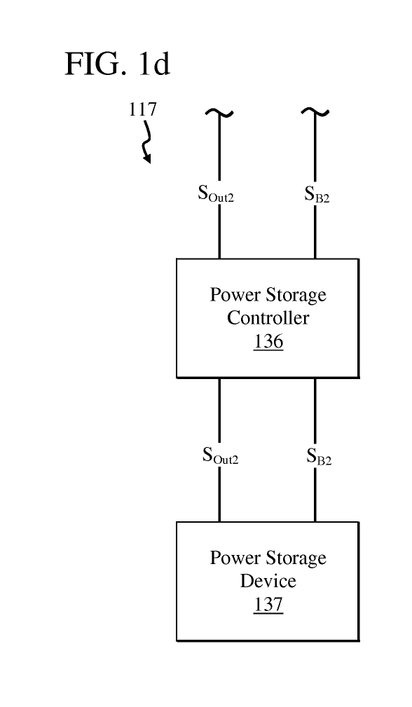

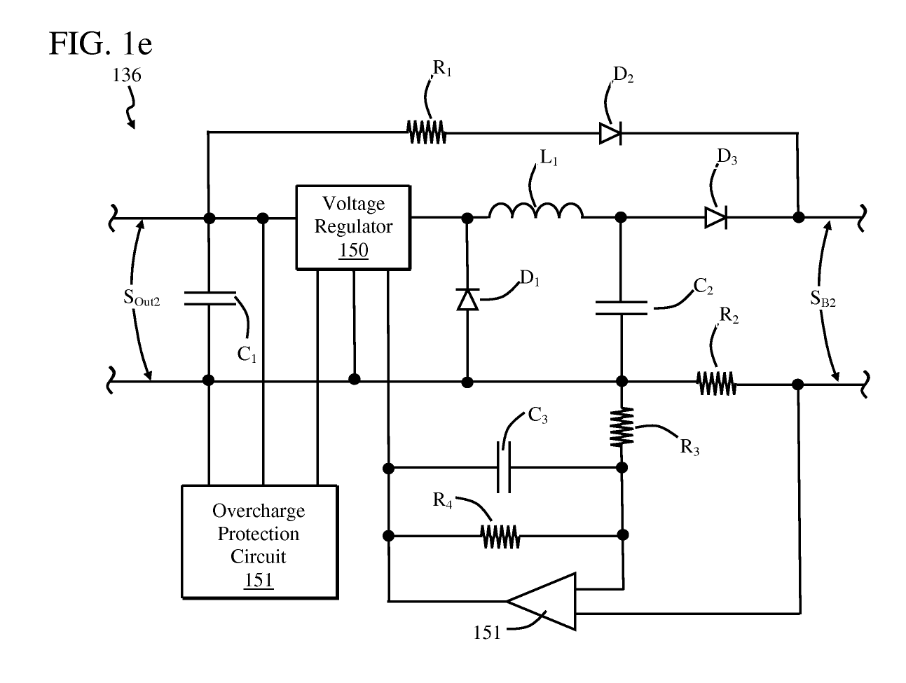

FIG. 1a is a block diagram of a system 100 which controls the operation of an electrical load, and provides power storage. In this embodiment, system 100 includes an electrical load 115 operatively coupled to a control assembly 110. Control assembly 110 can be of many different types. In this embodiment, control assembly 110 includes a current converter 111 in communication with a main controller 112, wherein main controller 112 is in communication with electrical load 115.

In operation, current converter 111 provides an output signal S_{Out}, when control assembly 110 is activated, in response to receiving an input signal S_{Input}. The output signal S_{Out} is provided to main controller 112, and main controller 112 provides an output signal S_{Out} to electrical load 115 when control assembly 110 is activated. Further, control assembly 110 does not provide output signal S_{Out}, when control assembly 110 is deactivated, in response to receiving input signal S_{Input}. It should be noted that control assembly 110 has an activated condition when it is activated, and control assembly 110 has a deactivated condition when it is deactivated.

It should also be noted that the output signal which flows between current converter 111 and main controller 112 corresponds to the output signal which flows between main controller 112 and electrical controller. These output signals are both identified as being output signal S_{Out} in FIG. 1a for simplicity and ease of discussion.

Signals S₁ and S_{Out} can be of many different types. In one embodiment, signals S₁ and S_{Out} are both AC signals. In another embodiment, signals S₁ and S_{Out} are both DC signals. In some embodiments, signals S₁ and S_{Out} are AC and DC signals, respectively. In some embodiments, signals S₁ and S_{Out} are DC and AC signals, respectively.

It should be noted that an AC signal generally oscillates as a function of time. In one example, the AC signal oscillates as a function of time in a periodic manner. An example of an AC signal that oscillates as a function of time in a periodic manner is a sinusoidal signal. A DC signal does not oscillate as a function of time in a periodic manner. Hence, an AC signal is not a DC signal. More information regarding AC and DC signals can be found in U.S. patent application Ser. No. 12/553,893. More information regarding AC power, DC power, AC signals and DC signals can be found in U.S. Pat. Nos. 5,019,767, 5,563,782, 6,061,261, 6,266,261, 6,459,175, 7,106,566 and 7,300,302, the contents of all of which are incorporated by reference as though fully set forth herein.

Current converter 111 receives input signal S_{Input} and provides output signal S_{Out} to control assembly 110 in response. Control assembly 110 receives output signal S_{Out} from current converter 111 and provides output signal S_{Out} in response. Control assembly 110 provides output signal S_{Out}, when main controller 112 is activated, in response to receiving input signal S_{Input}. Further, control assembly 110 does not provide output signal S_{Out}, when main controller 112 is deactivated, in response to receiving input signal S_{Input}.

Current converter 111 can be of many different types of converters, such as an AC-to-DC converter, an AC-to-AC converter, a DC-to-AC converter and a DC-to-DC converter. Examples of converters are disclosed in U.S. Pat. Nos. 5,347,211, 6,643,158, 6,650,560, 6,700,808, 6,775,163, 6,791,853 and 6,903,950, the contents of all of which are incorporated by reference as though fully set forth herein.

In some embodiments, main controller 112 and current converter 111 are positioned proximate to each other. Main controller 112 and current converter 111 can be positioned proximate to each other in many different ways. For example, main controller 112 and current converter 111 can be positioned proximate to each other by coupling them to the same support structure, such as a housing. In this way, main controller 112 and current converter 111 are carried by the same light switch housing. The housing can be of many different types, such as a light switch box and an electrical construction box. In one embodiment in which the housing is a light switch box, main controller 112 is a light switch. Light switch boxes and light switches are also discussed in more detail in the above-referenced U.S. patent application Ser. No. 12/553,893.

In some embodiments, control assembly 110 is housed by the housing. Control assembly 110 is housed by the housing when it extends through an internal volume of the housing. In other embodiments, control assembly 110 is not housed by the housing. Control assembly 110 is not housed by the housing when it does not extend through an internal volume of the housing.

In some embodiments, main controller 112 is housed by the housing. Main controller 112 is housed by the housing when it extends through an internal volume of the housing. In other embodiments, main controller 112 is not housed by the housing. Main controller 112 is not housed by the housing when it does not extend through an internal volume of the housing.

In some embodiments, current converter 111 is housed by the housing. current converter 111 is housed by the housing when it extends through an internal volume of the housing. In other embodiments, current converter 111 is not housed by the housing. Current converter 111 is not housed by the housing when it does not extend through an internal volume of the housing.

In some embodiments, a portion of control assembly 110 is housed by the housing and another portion of control assembly 110 is not housed by the housing. For example, in one embodiment, main controller 112 is housed by the housing and current converter 111 is not housed by the housing. In another embodiment, current converter 111 is housed by the housing and main controller 112 is not housed by the housing.

FIG. 1b is a block diagram of one embodiment of electrical load 115. In this embodiment, electrical load 115 includes a load device 118 operatively coupled to a load system controller 116, and a power storage system 117 operatively coupled to load system controller 116. It should be noted that load system controller 116 receives power signal S_{Out} from control assembly 110 (FIG. 1a). In particular, load system controller 116 receives power signal S_{Out} from main controller 112. In some embodiments, main controller 112 and load system controller 116 are in communication with each other. Main controller 112 and load system controller 116 can be in communication with each other in many different ways, such as through a wired communication link and a wireless communication link. In some embodiment, main controller 112 controls the operation of load system controller 116.

In one mode of operation, load system controller 116 provides an output signal S_{Out1} to load device 118 in response to receiving output signal S_{Out}. Load device 118 operates in response to receiving output signal S_{Out1}. Load device 118 can operate in many different ways, several of which are discussed in more detail below. It should also be noted that the output signal which flows to load system controller 116 corresponds to the output signal which flows between load system controller 116 and load device 118. However, these output signals are both identified as being output signals S_{Out} and S_{Out1}, respectively, in FIG. 1a for ease of discussion.

Load device 118 can be of many different types of devices, such as a light emitting device and an appliance. The light emitting device can be of many different types, such as a solid-state light emitting device. One type of solid-state light emitting device is a light emitting diode. Examples of light emitting diode are disclosed in U.S. Pat. Nos. 7,161,311, 7,274,160 and 7,321,203, as well as U.S. Patent Application No. 20070103942. Other types of lighting devices include incandescent and fluorescent lamps. The appliance can be of many different types, such as a computer television, fan, ceiling fan, refrigerator, and microwave oven, among others. In general, the appliance operates in response to receiving output signal S_{Out}.

In another mode of operation, load system controller 116 provides an output signal S_{Out2} to power storage system 117 in response to receiving output signal S_{Out}. Power storage system 117 operates in response to receiving output signal S_{Out2}. Power storage system 117 can operate in many different ways, several of which are discussed in more detail below. Power storage system 117 can be of many different types of devices, such as a battery. The battery can be of many different types, such as a rechargeable battery. It should also be noted that the output signal which flows to load system controller 116 corresponds to the output signal which flows between load system controller 116 and power storage system 117. However, these output signals are both identified as being output signals S_{Out} and S_{Out2}, respectively, in FIG. 1a for ease of discussion.

In this embodiment, power storage device 117 operates as a rechargeable battery which provides a power signal S_{B2} to load system controller 116, and load system controller 116 provides a power signal S_{B1} to load device 118. It should be noted that power signals S_{B1} and S_{B2} can be the same or different power signals. It should also be noted that power signals S_{B1} and S_{B2} can be provided to load device 118 when control assembly 110 is deactivated so that output signal S_{Out} is not provided to load system controller 116. In this way, load device 118 can be provided with power when control assembly 110 is activated and deactivated.

FIG. 1c is a block diagram of one embodiment of load system controller 116. In this embodiment, load system controller 116 includes a switch 133 in communication with a switch 135. In this embodiment, switches 133 and 135 are operatively coupled to a load control circuit 134. It should not that, in some embodiments, load control circuit 134 is operatively coupled to main controller 112, so that main controller 112 controls the operation of load control circuit 134. In this embodiment, switch 133 is activated and deactivated in response to receiving a control signal S_{Control1} from load control circuit 134. Further, switch 135 is activated and deactivated in response to receiving a control signal S_{Control2} from load control circuit 135. Switches 133 and 135 can be of many different types, such as solid state switches and relays. Examples of solid state switches include transistors.

In one mode of operation, switch 133 provides output signal S_{Out} to switch 135 in response to being activated by control signal S_{Control1} from control circuit 134. It should be noted that output signal S_{Out} is provided to load system controller 116 by control assembly 110. In particular, output signal S_{Out} is provided to load system controller 116 by main assembly 112. Switch 135 receives output signal S_{Out} from switch 133 and, in response to being activated by control signal S_{Control2} from control circuit 134, provides output signal S_{Out1} to load device 118 (FIG. 1b). As mentioned above, output signals S_{Out} and S_{Out1} can be the same signals or different signals. Load device 118 operates in response to receiving output signal S_{Out1}.

In another mode of operation, switch 133 provides output signal S_{Out2} to power storage system 117 (FIG. 1b) in response to being activated by control signal S_{Control1} from control circuit 134. Power storage system 117 receives output signal S_{Out2} from switch 133 and operates in response. Power storage system 117 can operate in many different ways, such as by storing power. As mentioned above, output signals S_{Out} and S_{Out2} can be the same signals or different signals.

In the embodiment in which power storage device 117 operates as a rechargeable battery, power storage device 117 provides power signal S_{B2} to switch 135. Switch 135 receives power signal S_{B2} from power storage device 117 and, in response to being activated by control signal S_{Control2} from control circuit 134, provides power signal S_{B2} to load device 118 (FIG. 1b).

FIG. 1d is a block diagram of one embodiment of power storage device 117. In this embodiment, power storage device 117 includes power storage controller 136 operatively coupled to a power storage device 137. Power storage device 137 can be of many different types, such as a battery and rechargeable battery. It should be noted that power storage controller 136 can be operatively coupled to the other control circuits discussed herein. In some embodiments, power storage controller 136 is operatively coupled to main controller 112 (FIG. 1a). In some embodiments, power storage controller 136 is operatively coupled to load system controller 116 (FIG. 1b). In some embodiments, power storage controller 136 is operatively coupled to load control circuit 134 (FIG. 1c).

In one mode of operation, output signal S_{Out2} is received by power storage controller 136 and, in response to a store power indication, power storage controller 136 provides output signal S_{Out2} to power storage device 137. Power storage device 137 stores power in response to receiving output signal S_{Out2} in response to power storage controller 136 receiving the store power indication. The store power indication can be provided to power storage device 137 by many different controllers, such as the ones discussed in FIGS. 1a, 1b and 1c.

In another mode of operation, power signal S_{B2} is provided to power storage controller 136 and, in response to a provide power indication, power storage controller 136 provides power signal S_{B2}. In the embodiment of FIG. 1b, power signal S_{B2} is provided to load system controller 116. In the embodiment of load system controller 116 of FIG. 1c, power signal S_{B2} is provided to switch 135. The provide power indication can be provided to power storage device 137 by many different controllers, such as the ones discussed in FIGS. 1a, 1b and 1c.

FIG. 1e is a circuit diagram of one embodiment of power storage controller 136. In this embodiment, power storage controller 136 includes a circuit that is sometimes referred to as a High-Efficiency 3 Amp Battery Charger which Uses a LM2576 Regulator. More information regarding this circuit can be found in Application Note 946 (AN-946), by Chester Simpson, dated May 1994, and provided by National Semiconductor. The components of the circuit are represented by conventional circuit symbols to denote resistors (R), capacitors (C), inductors (I), diodes (D) and an operation amplifier, which is denoted as element 152. The circuit includes a voltage regulator which is the LM2576 voltage regulator. However, it should be noted that other voltage regulators can be used. In this embodiment, the circuit includes an overcharge protection circuit 151, and more information regarding one embodiment of overcharge protection circuit 151 is provided in AN-946.

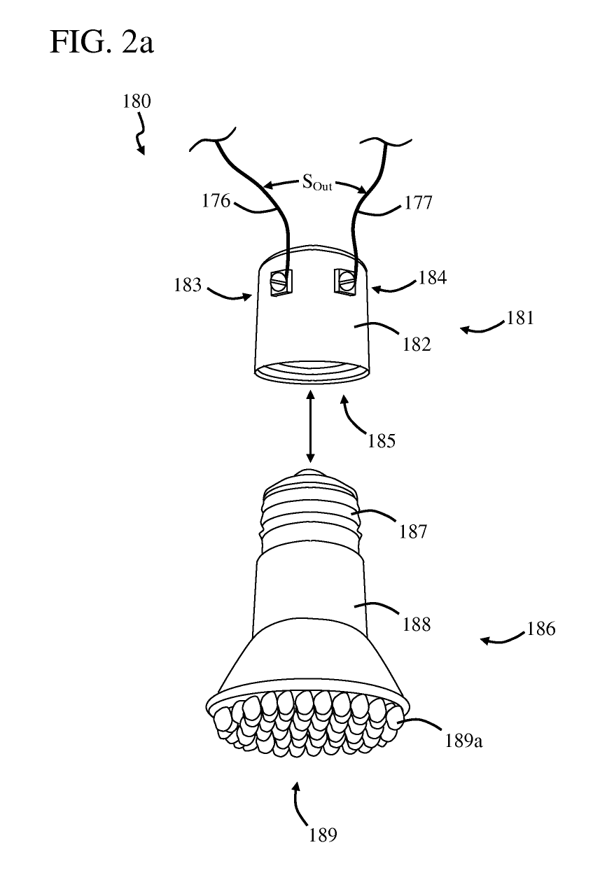

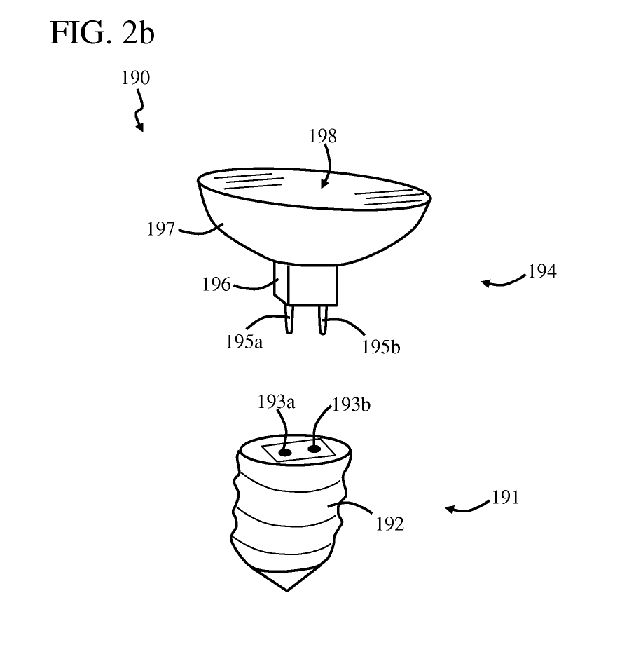

FIG. 2a is a perspective view of load device 118 embodied as a solid-state light emitting device 180. In this embodiment, solid-state light emitting device 180 includes a light socket 181, which includes a light socket body 182. Light socket 181 carries light socket terminals 183 and 184, wherein light socket terminals 183 and 184 are connected to lines 176 and 177. Light socket terminals 183 and 184 are connected to lines 176 and 177 so that output signal S_{Out} is provided to solid-state light emitting device 180. Light socket body 182 includes a receptacle 185 for receiving a lamp, such as a solid-state light emitting device, which will be discussed in more detail presently.

In this embodiment, solid-state light emitting device 180 includes a solid-state lamp 186, which includes a solid-state lamp body 188. Solid-state lamp 186 includes a light socket connector 187 sized and shaped to be received by receptacle 185. Solid-state lamp 186 includes a LED array 189 which includes a plurality of LED's 189a. It should be noted that, in general, solid-state lamp 186 includes one or more LED's. LED array 189 can emit many different colors of light, such as white light.

In one mode of operation, load system controller 116 provides an output signal S_{Out1} to solid-state light emitting device 180 in response to receiving output signal S_{Out}. Solid-state light emitting device 180 operates in response to receiving output signal S_{Out1}. Solid-state light emitting device 180 can operate in many different ways, such as by emitting light.

In another mode of operation, power storage device 117 operates as a rechargeable battery which provides a power signal S_{B2} to load system controller 116, and load system controller 116 provides a power signal S_{B1} to solid-state light emitting device 180. It should be noted that power signals S_{B1} and S_{B2} can be the same or different power signals. It should also be noted that power signals S_{B1} and S_{B2} can be provided to solid-state light emitting device 180 when control assembly 110 is deactivated so that output signal S_{Out} is not provided to load system controller 116. In this way, solid-state light emitting device 180 can be provided with power when control assembly 110 is activated and deactivated.

It should be noted that electrical load 115 is shown as a separate component from control assembly 110 in FIG. 1a. However, in some embodiments, control assembly 110 can be included with electrical load 115, as will be discussed in more detail presently.

FIG. 2b is a perspective view of a load device embodied as a lamp 190. Lamp 190 can be of many different types, such as an multifaceted reflector (MR) lamp. There are many different types of multifaceted reflector lamps, such as an MR 16 lamp. Multifaceted reflector lamps are made by many different manufacturers, such as Westinghouse, General Electric and Sylvania, amount others.

In this embodiment, lamp 190 includes a cap assembly 191, which includes a cap 192 which carries connectors 193a and 193b. In this embodiment, cap assembly 191 includes control assembly 110 (FIG. 1) in communication with connectors 193a and 193b. In particular, cap assembly 191 includes current converter 111 and main controller 112, wherein main controller 112 is in communication with connectors 193a and 193b. It should be noted that, in this embodiment, output signal S_{Out} flows between connectors 193a and 193b. In some embodiments, cap assembly 191 includes load system controller 116 and power storage system 117 of FIG. 1b. In some embodiments, load system controller 116 of cap assembly 191 is embodied as shown in FIG. 1c. In some embodiments, power storage system 117 of cap assembly 191 is embodied as shown in FIG. 1d. In some embodiments, power storage system 117 of cap assembly 191 includes the circuit of FIG. 1e.

In this embodiment, lamp 190 includes a lamp assembly 194, which is repeatably moveable between connected and unconnected conditions with cap assembly 191. Lamp assembly 194 includes a lamp base 196 which carries a lens housing 197. Lens housing 197 carries a lens 198. Lamp assembly 194 includes a lamp (not shown) which is in communication with complementary connectors 195a and 195b, wherein complementary connectors 195a and 195b extend through lamp base 196. In the connected condition, connectors 193a and 193b and complementary connectors 195a and 195b, respectively, are connected together so that power signal S_{Out} can flow therethrough. In the unconnected condition, connectors 193a and 193b and complementary connectors 195a and 195b, respectively, are unconnected from each other so that power signal S_{Out} cannot flow therethrough. The lamp of lamp assembly 194 provides light in response to power signal S_{Out} flowing between complementary connectors 195a and 195b.

In one mode of operation, load system controller 116 of cap assembly 191 provides output signal S_{Out1} to the lamp of lamp assembly 194 in response to receiving output signal S_{Out}. The lamp of lamp assembly 194 operates in response to receiving output signal S_{Out1}. The lamp of lamp assembly 194 can operate in many different ways, such as by emitting light.

In another mode of operation, power storage device 117 of cap assembly 191 operates as a rechargeable battery which provides power signal S_{B2} to load system controller 116, and load system controller 116 provides power signal S_{B1} to the lamp of lamp assembly 194. It should be noted that power signals S_{B1} and S_{B2} can be the same or different power signals. It should also be noted that power signals S_{B1} and S_{B2} can be provided to the lamp of lamp assembly 194 when control assembly 110 is deactivated so that output signal S_{Out} is not provided to load system controller 116. In this way, the lamp of lamp assembly 194 can be provided with power when control assembly 110 is activated and deactivated.

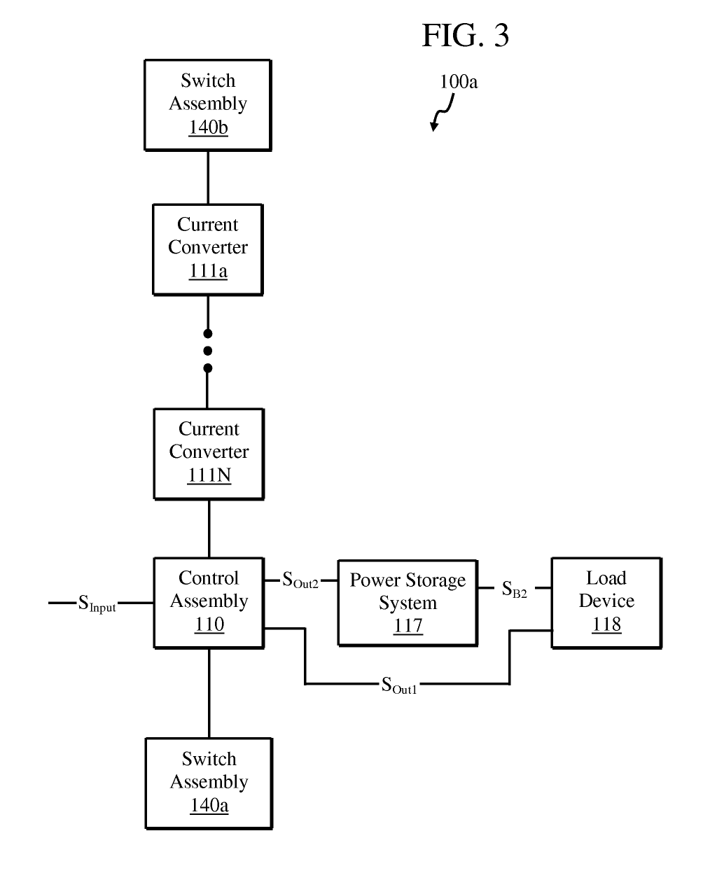

FIG. 3 is a block diagram of a system 100a which controls the operation of an electrical load, and provides power storage. In this embodiment, system 100a includes power storage system 117 operatively coupled to control assembly 110, and load device 118 operatively coupled to power storage system 117. More information regarding control assembly 110, power storage system 117 and load device 118 is provided above.

In this embodiment, system 100a includes switch assembly 140a in communication with control assembly 110. Control assembly 110 is repeatably moveable between the activated and deactivated conditions in response to activating and deactivating switch assembly 140a. When control assembly 110 is in the activated condition in response to activating switch assembly 140a, output signal S_{Out1} flows between control assembly 110 and load device 118. In this way, load device 118 operates in response to receiving output signal S_{Out1}.

In this embodiment, system 100a includes switch assembly 140b in communication with control assembly 110 through a number N of current converters 111a, 111b, . . . 111N, wherein N is a whole number greater than or equal to one. The number N is chosen to provide a desired amount of current to control assembly 110. The amount of current provided to control assembly 110 increases and decreases in response to increasing N and decreasing N, respectively. The current flow through the current converters 111a, 111b, . . . 111N is controlled by activating and deactivating switch assembly 140b. The current flows through current converters 111a, 111b, . . . 111N when switch assembly 140b is activated, and the current is restricted from flowing through current converters 111a, 111b, . . . 111N when switch assembly 140b is deactivated.

When control assembly 110 is in the activated condition in response to activating switch assembly 140a, output signal S_{Out2} flows between power storage system 117 can control assembly 110, and power storage system 117 stores power in response. If desired, power storage system 117 provides power signal S_{B2} to load device 118. In this way, load device operates in response to receiving power signal S_{B2}. It should be noted that, in some situations, load device 118 operates in response to receiving signals S_{Out1} and S_{B2}. In some situations, load device 118 operates in response to receiving one of signals S_{Out1} and S_{B2}.

It should be noted that switch assemblies 140a and 140b can be of many different types, such as a light switch assembly and dimmer switch assembly. More information regarding switch assemblies is provided in U.S. patent application Ser. No. 12/553,893.

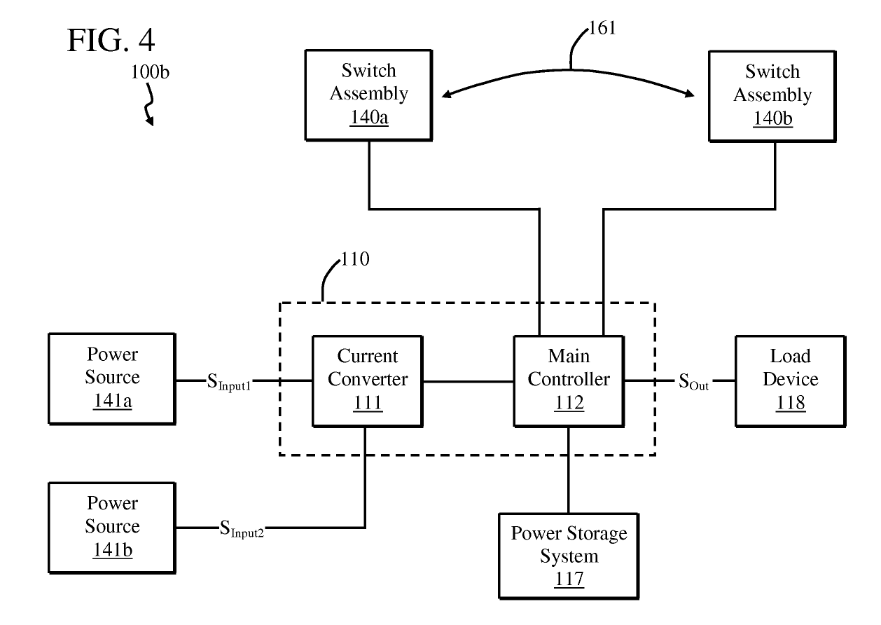

FIG. 4 is a block diagram of a system 100b which controls the operation of an electrical load, and provides power storage. In this embodiment, system 100b includes power storage system 117 operatively coupled to control assembly 110, and load device 118 operatively coupled to power storage system 117. More information regarding control assembly 110, power storage system 117 and load device 118 is provided above.

In this embodiment, system 100b includes a power source 141a which provides a power input signal S_{Input1} to control assembly 110. Further, system 100b includes a power source 141b which provides a power input signal S_{Input2} to control assembly 110. Power sources 141a and 141b can be of many different types. In one embodiment, power system 141a is a power grid and power source 141b is an alternative power source. Power source 141b can be of many different types of alternative power sources. Examples of alternative power sources include a solar power source, wind turbine power source, water power source, and a biomass power source, among others. In operation, control assembly 110 provides power signal S_{Out} to load device 118, wherein power signal S_{Out} corresponds to power input signal S_{Input1} and/or S_{Input2}. In this embodiment, the flow of power input signals S_{Input1} and/or S_{Input2} and power signal S_{Out} is adjustable in response to adjusting switch assemblies 140a and/or 140b.

In some embodiments, switch assemblies 140a and 140b are in communication with each other. Switch assemblies 140a and 140b can be in communication with each other in many different ways, such as through a wired like and a wireless link. In some embodiments, switch assembly 140a controls the operation of switch assembly 140b through a wireless communication link. The wireless communication link can be established in many different ways, such as by including a wireless module with switch assemblies 140a and 140b. The wireless module can be of many different types such as those made by Microchip and Atmel Corporation.

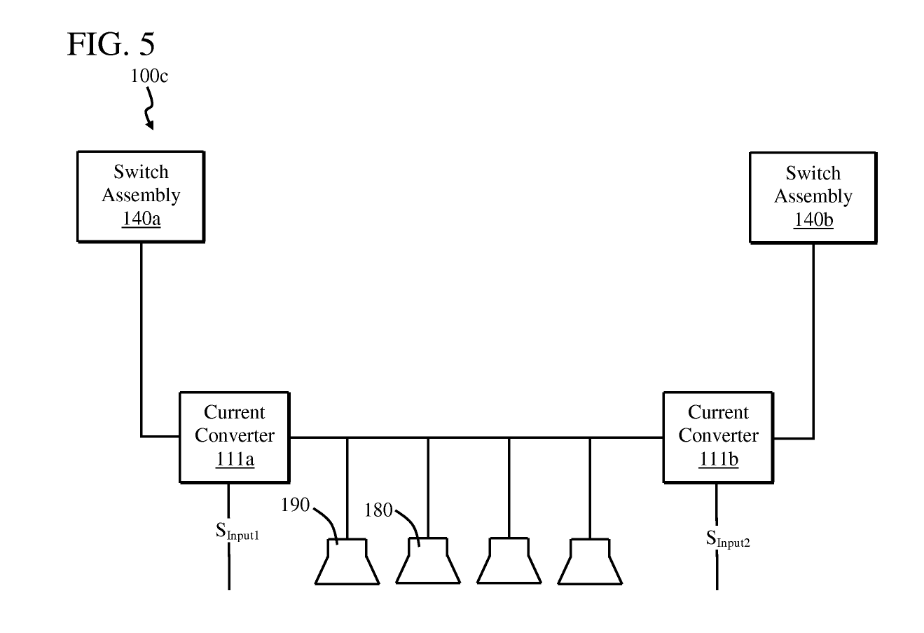

FIG. 5 is a block diagram of a system 100c which controls the operation of an electrical load, and provides power storage. In this embodiment, system 100c includes current converters 111a and 111b operatively coupled to switch assemblies 140a and 140b, respectively. System 100c includes a plurality of lamps operatively coupled to current converters 111a and 111b. The lamps of system 100c can be of many different types, such as solid-state light emitting device 180 and lamp 190, which are discussed in more detail above.

In operation, current converters 111a and 111b receive input signals S_{Input1} and S_{Input2}, respectively. Input signals S_{Input1} and S_{Input2} can be provided in many different ways, such as by the power sources mentioned above. Current converter 111a is repeatably moveable between activated and deactivated conditions in response to activating and deactivating switch assembly 140a. The lamps of system 100c are activated and deactivated in response to activating and deactivating current converter 111a. In this way, the light outputted by the lamps of system 100c is controllable.

Further, current converter 111b is repeatably moveable between activated and deactivated conditions in response to activating and deactivating switch assembly 140b. The lamps of system 100c are activated and deactivated in response to activating and deactivating current converter 111b. In this way, the light outputted by the lamps of system 100c is controllable.

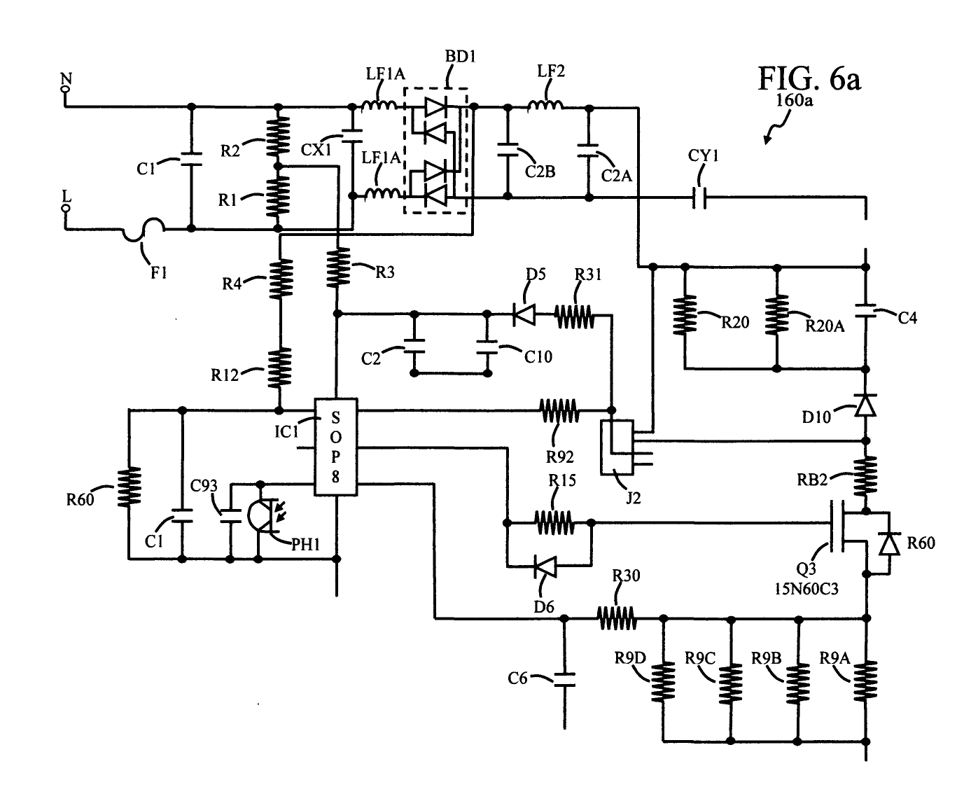

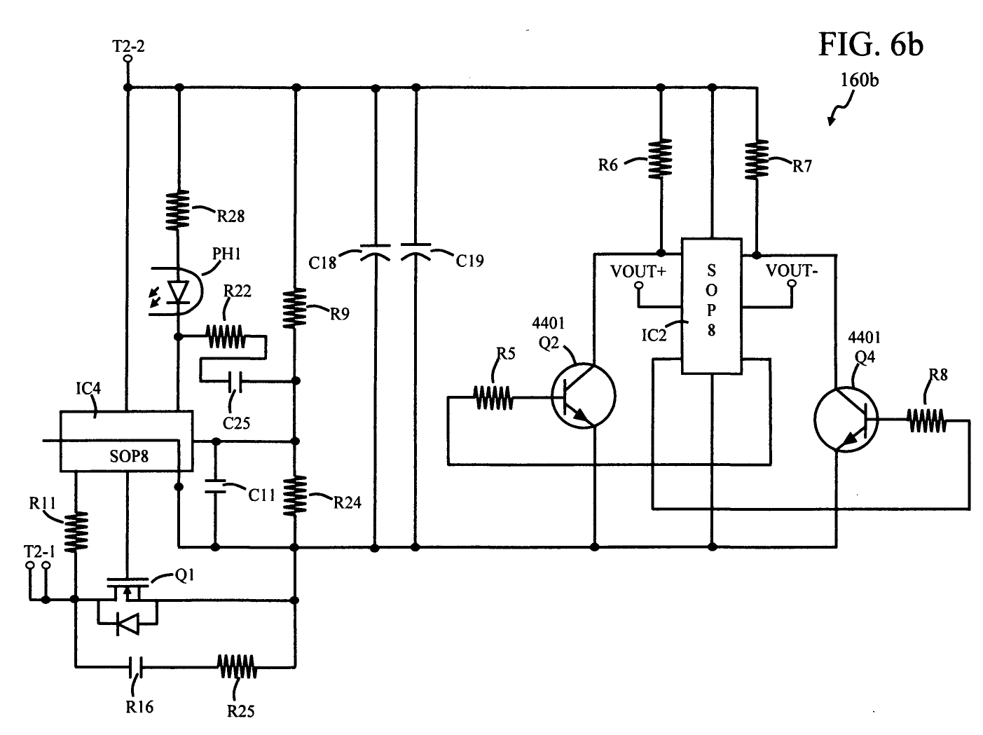

FIGS. 6a and 6b are block diagrams of circuits 160a and 160b which are included in a light switch assembly. Circuits 160a and 160b allow the light switch assembly to repeatably move between activated and deactivated conditions, as described in more detail above with FIG. 5. Circuits 160a and 160b allow the light switch assemblies to adjust the power of the signals provided to the lamps of system 100c. The powers of the signals provided to the lamps of system 100c can be adjusted in many different ways, such as by adjusting the voltage. More information regarding adjusting the power of a signal is provided in U.S. patent application Ser. No. 12/553,893.

The embodiments of the invention described herein are exemplary and numerous modifications, variations and rearrangements can be readily envisioned to achieve substantially equivalent results, all of which are intended to be embraced within the spirit and scope of the invention as defined in the appended claims.

1. A system, comprising:
an electrical load;
a power storage system;
a control assembly which controls the flow of a first power signal to the electrical load and power storage system; and
wherein the control assembly controls the flow of a second power signal between the power storage system and electrical load;
a housing which carries the power storage system and control assembly.

2. The system of claim 1, wherein the control assembly does not provide the first power signal, when the control assembly is deactivated, in response to receiving an input signal.

3. The system of claim 1, further including a light switch assembly which includes the control assembly and housing.

4. The system of claim 1, wherein the flow of the second power signal between the power storage system and electrical load is adjustable in response to adjusting a control signal between the control assembly and electrical load.

5. The system of claim 1, wherein the power storage system includes a battery which stores the power in response to receiving the first power signal.

6. The system of claim 1, wherein the electrical load includes a solid-state light emitting device.

7. The system of claim 1, wherein the control assembly includes an AC-to-DC converter and main controller, wherein the control assembly provides the first power signal, when the main controller is activated.

8. The system of claim 1, wherein the electrical load includes a current converter and load controller operatively coupled together.

9. A system, comprising:
a lighting system which includes a light emitting device and power storage system; and
a first control assembly which controls the flow of a first power signal to the light emitting device and power storage system;
wherein the first control assembly controls the flow of a second power signal between the power storage system and light emitting device.

10. The system of claim 9, wherein the first control assembly does not provide the first power signal, when the first control assembly is deactivated, in response to receiving an AC signal.

11. The system of claim 9, further including a light switch assembly which includes the first control assembly.

12. The system of claim 9, wherein the flow of the second power signal between the power storage system and light emitting device is adjustable in response to adjusting a control signal between the first control assembly and lighting system.

13. The system of claim 9, wherein the power storage system includes a battery which stores the power in response to receiving the first power signal.

14. The system of claim 9, wherein the lighting system includes a solid-state light emitting device.

15. The system of claim 9, wherein the first control assembly includes an AC-to-DC converter and main controller, wherein the first control assembly provides the first power signal, when the main controller is activated.

16. The system of claim 9, wherein the lighting system includes an AC-to-DC converter and lighting controller operatively coupled together.

17. The system of claim 9, further including a second control assembly in communication with the first control assembly.

18. The system of claim 9, further including a second control assembly in wireless communication with the first control assembly.

19. The system of claim 9, further including a second control assembly which controls the operation of the first control assembly through a wireless communication link.
